(19) United States
(12) Patent Application Publication
(10) Pub. No.: US 2024/0152859 A1
(43) Pub. Date: May 9, 2024

(54) ADAPTIVE DETENTION SYSTEM AND METHODS

(71) Applicant: Detention Source, LLC, Fort Wayne, IN (US)

(72) Inventor: Brad Sneary, Fort Wayne, IN (US)

(21) Appl. No.: 18/475,168

(22) Filed: Sep. 26, 2023

Related U.S. Application Data
(60) Provisional application No. 63/382,884, filed on Nov. 8, 2022.

(51) Int. Cl. G06Q 10/0833

(52) U.S. Cl. CPC G06Q 10/0833

(57) ABSTRACT

A detention system comprising first, second, and third devices respectively associated with a driver device, an electronic logging device (ELD), and a dispatcher device that are in communication with each other. The driver device may include a hardware processor and physical memory having a computer program including instructions that upon execution of the hardware processor provide operations. The operations may include to receive pre-defined geofences respectively associated with a shipper location and a receiver location, receive user selections related to the detention information and pre-defined geofences, determine whether the user selections have met a difference threshold, and adapt the detention information in response to meeting the difference threshold.

### CROSS-REFERENCE TO RELATED APPLICATIONS

This US Non-Provisional Patent Application is based on and claims priority to U.S. Provisional Patent Application No. 63/382,884 filed Nov. 8, 2022, which is hereby incorporated by reference in its entirety.

### BACKGROUND

In the transportation or trucking industry, typical detention procedures are a grey area due to inadequate communication between the associated users, e.g., drivers, customers, shippers, receivers, and dispatchers. Traditional approaches depend on antiquated, manual processes that are highly subjective and vary throughout the industry, and discrepancies arise due to conflicting perspectives of the users involved.

With the recent mandate of electronic logging devices (ELDs), it is now more important than ever that drivers are paid for the time spent detained past the present allotted time to get loaded/unloaded at shippers and receivers. Any time a driver is detained past the allotted amount of time to get loaded/unloaded, it results in less drive time for the driver, which directly affects a driver's weekly schedule and ability to earn.

For instance, a driver arrives at a shipper or receiver before an appointment time to check in to pick up or to deliver a load. The check-in process varies depending on each facility and staff, resulting in unpredictable delays. If there are abnormal wait times to check in due to inadequate scheduling, cluster of drivers arriving all at the same time, construction, or worker shortages, these delays in the check-in process are no fault of the driver. However, these may result in the driver being unfairly faulted for missed appointments, exceeded allotted times, and detention voids.

Traditional approaches result in inaccuracies and confusion throughout the transportation process. For late arrivals, it is difficult to determine whether the driver is at fault for arriving late or a shipper and/or receiver for not having a more efficient check-in process. For discrepancies in manual logs for check-in and check-out times, it is difficult to determine which party has accurate information or whether the times were correctly or incorrectly logged. These inaccuracies may result in the driver not being compensated for detention or the customer unnecessarily paying for detention.

There is also a need to reduce manual labor when it comes to requesting and managing detention requests. Traditional procedures require drivers to manually record or write their in-times and out-times on the bill of lading (BOL) and/or proof of delivery (POD), which is sent to a dispatcher who forwards these documents to a customer service representative (CSR) who may ultimately request detention from a customer. The CSR must manually calculate exactly how many hours of detention to be requested and must know that particular customer's detention policy to know the exact dollar amount to be requested. These manual processes are prone to mistakes.

Traditional approaches are also subject to extensive wait times. After the traditional CSR receives the BOL or POD from the driver/dispatcher and has done the proper calculations, the CSR makes a submission to request for detention from the customer by either manually emailing the appropriate contact, or manually uploading the information to a transportation management system, with all of the load information (e.g., load number, bill of lading number, in/out times, location of where the detention occurred, how many hours of detention are being requested for, how much money is being requested for the detention, etc.). The CSR must then wait until the customer verifies all the information that was provided with the actual location where the detention occurred. The typical wait times range from a couple days to weeks.

Traditional processes can include multiple follow-up emails between all parties (e.g., CSR, customer, and detention location). After the request from the CSR has been reviewed by the customer, the customer may either decline the request (e.g., due to conflicting information, check-in, and/or check-out times) or approve the request. After the customer provides validation to the CSR that the customer agrees to pay the carrier detention for the load, the CSR then provides this information to the billing department so they can make the proper adjustments to the entire order to include billing for detention.

The present disclosure provides solutions and improvements over traditional systems. With the adaptive detention system and methods provided, automatically performs the work of gathering information, providing accurate calculations, sending out requests, following up with appropriate contacts, receiving validation of payment, etc. The present disclosure also makes it easier for the customer to be able to approve or decline detention requests by having the most accurate information within minutes from departure of an order having detention.

There is a need for an autonomous detention system and methods of the present disclosure that provides improvements over traditional approaches. This includes improved transparency and communication of detention information between users such as customers, drivers, and dispatchers. The systems herein also facilitate improved requests and reports of detention information.

### BRIEF DESCRIPTION OF THE DRAWINGS

FIG. 1 illustrates an exemplary hardware system for providing operations of the present disclosure;

FIG. 2 illustrates an exemplary user interface for operations of the present disclosure, e.g., for carrier login;

FIG. 3 illustrates an exemplary user interface for operations of the present disclosure, e.g., for order creation;

FIG. 4 illustrates an exemplary user interface for operations of the present disclosure, e.g., for customer profiles;

FIG. 5 illustrates an exemplary user interface for operations of the present disclosure, e.g., for driver profiles;

FIG. 6 illustrates an exemplary user interface for operations of the present disclosure, e.g., for account information;

FIG. 7 illustrates an exemplary user interface for operations of the present disclosure, e.g., for payment information;

FIG. 8 illustrates an exemplary user interface for operations of the present disclosure, e.g., for user logins;

FIG. 9 illustrates an exemplary user interface for operations of the present disclosure, e.g., for user information;

FIG. 10 illustrates an exemplary user interface for operations of the present disclosure, e.g., for shipment information;

FIG. 11 illustrates an exemplary user interface for operations of the present disclosure, e.g., for account balance information;

FIG. 12 illustrates an exemplary user interface for operations of the present disclosure, e.g., for shipper arrival information;

FIG. 13 illustrates an exemplary user interface for operations of the present disclosure, e.g., for shipper departure information;

FIG. 14 illustrates an exemplary user interface for operations of the present disclosure, e.g., for receiver arrival information;

FIG. 15 illustrates an exemplary user interface for operations of the present disclosure, e.g., for receiver departure information;

FIG. 16 illustrates an exemplary user interface for operations of the present disclosure, e.g., for adding images to bill of lading (BOL) information;

FIG. 17 illustrates an exemplary user interface for operations of the present disclosure, e.g., for arrived-to shipper notifications;

FIG. 18 illustrates an exemplary user interface for operations of the present disclosure, e.g., for arrived-to-receiver notifications;

FIG. 19 illustrates an exemplary user interface for operations of the present disclosure, e.g., for delivery appointment alerts;

FIG. 20 illustrates an exemplary user interface for operations of the present disclosure, e.g., for adding and updating account details;

FIG. 21 illustrates an exemplary user interface for operations of the present disclosure, e.g., for shipper arrival notifications of the driving arriving at a pickup location;

FIG. 22 illustrates an exemplary user interface for operations of the present disclosure, e.g., for shipper departure notifications of the driver departing a pickup location;

FIG. 23 illustrates an exemplary user interface for operations of the present disclosure, e.g., for detention warning notifications that the driver entered detention at the shipper and is waiting to be loaded;

FIG. 24 illustrates an exemplary user interface for operations of the present disclosure, e.g., for detention notifications of that the driver has departed the shipper pickup location and was detained for a period of time past an allotted time for the appointment;

FIG. 25 illustrates an exemplary user interface for operations of the present disclosure, e.g., for receiver arrival notifications of the driver has arrived at the receiver delivery location;

FIG. 26 illustrates an exemplary user interface for operations of the present disclosure, e.g., for receiver departure notifications that the driver has departed the receiver delivery location;

FIG. 27 illustrates an exemplary user interface for operations of the present disclosure, e.g., for detention warning notifications that driver has entered the receiver detention location;

FIG. 28 illustrates an exemplary user interface for operations of the present disclosure, e.g., for detention notifications that driver has departed delivery location and was detained for a period of time past the allotted time for the appointment;

FIG. 29 illustrates an exemplary user interface for operations of the present disclosure, e.g., for notification of approval, denial, or modification including arrival information for the shipper and/or receiver.

FIG. 30 illustrates an exemplary user interface for operations of the present disclosure, e.g., for approval of detention information including arrival information for the shipper and/or receiver.

FIG. 31 illustrates an exemplary user interface for operations of the present disclosure, e.g., for approval of detention information including arrival information for the shipper and/or receiver;

FIG. 32 illustrates an exemplary user interface for operations of the present disclosure, e.g., for denial of detention information and entry of associated reasoning;

FIG. 33 illustrates an exemplary user interface for operations of the present disclosure, e.g., for notification of declined detention information;

FIG. 34 illustrates an exemplary user interface for operations of the present disclosure, e.g., for modifying detention information;

FIG. 35 illustrates an exemplary user interface for operations of the present disclosure, e.g., for acceptance of modified detention information;

FIG. 36 illustrates an exemplary user interface for operations of the present disclosure, e.g., for notification with proof of arrival at the shipper and/or receiver;

FIG. 37 illustrates an exemplary process for executing operations of the present disclosure, e.g., for detention information of a plurality of devices; and

FIG. 38 illustrates another exemplary process for executing operations of the present disclosure, e.g., for detention information of a plurality of devices.

### DETAILED DESCRIPTION

A detention system may include first, second, and third devices respectively associated with a driver, an electronic logging device (ELD), and a dispatcher. The driver device may include a hardware processor and physical memory having a computer program including instructions that upon execution of the hardware processor provide operations. The system may provide operations to receive pre-defined geofences (e.g., distance, radius, area, or zone) respectively associated with a shipper location and a receiver location, receive user selections related to the detention information and pre-defined geofences, determine whether the user selections have met a difference threshold, and adapt the detention information in response to meeting the difference threshold.

The system may further include operations to receive order information from a transportation management system (TMS), automatically monitor a driver location of the driver device relative to the pre-defined geofences, receive and compare origin information, detention policy information, and destination information relative to the monitored driver location, transmit and display notifications in response to comparison, aggregate at least one of origin, detention policy, allotted time, detention rate, and destination information from the first, second, and third devices, and automatically generate notifications in response to the determination of meeting the detention threshold.

A detention method may comprise receiving detention information of first, second, and third devices, receiving pre-defined geofences respectively associated with a shipper location and a receiver location, receiving user selections related to the detention information and pre-defined geofences, determining whether the user selections have met a difference threshold, and adapting the detention information in response to meeting the difference threshold.

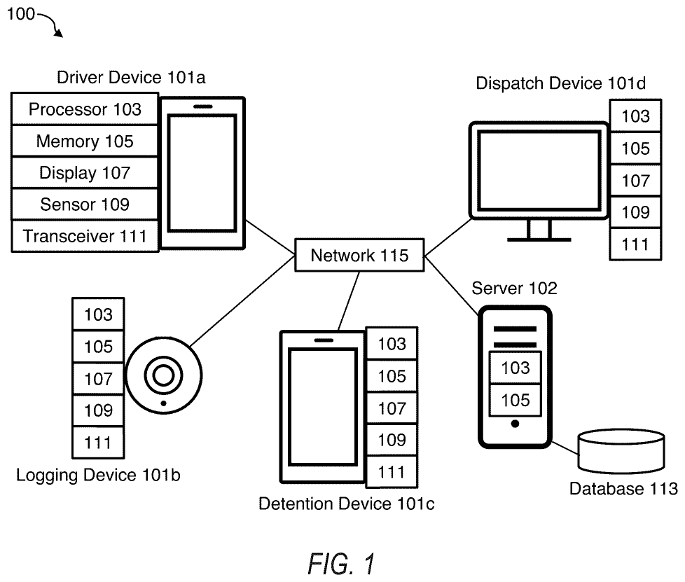

FIG. 1 illustrates exemplary system 100, e.g., an autonomous detention system. System 100 may include one or more computing devices 101, computer server 102, hardware processor 103, physical memory 105, hardware display 107, sensor 109, transceiver 111, database 113, and network 115 in communication with each other, e.g., to respectively or collectively perform the operations as disclosed herein. Devices 101 may include driver device 101a, logging device 101b, detention device 101c, dispatch, receiver and/or shipper device 101d, or a combination thereof. System 100 may receive and communicate information (e.g., detention information) by way of user inputs to user interface 200, devices 101, server 102, and network 115.

Detention information may include any information of system 100 as disclosed herein including, for example, a pick-up/shipper address (e.g., appointing a pick-up geofence for a driver), pick-up date/time (e.g., confirming or validating driver's appointment at pick-up), delivery/receiver address (e.g., defining or appointing a delivery geofence for the driver), delivery date/time (e.g., confirming or validating driver's appointment at delivery), load identifier (e.g., load identification), bill of lading (BOL) identifier (e.g., second identification), driver's phone number (e.g., operationally connected to each related order), customer profile (e.g., pre-defined customer terms, detention policy, and contacts for detention requests), allotted time (e.g., pre-defined if customer profile is selected, gives the amount of free time from appointment time until detention is accrued, and varies from customer to customer), hourly charge (e.g., hourly rate after driver enters detention), customer contact information (e.g., e-mail address of user that approves or denies detention requests), or a combination thereof.

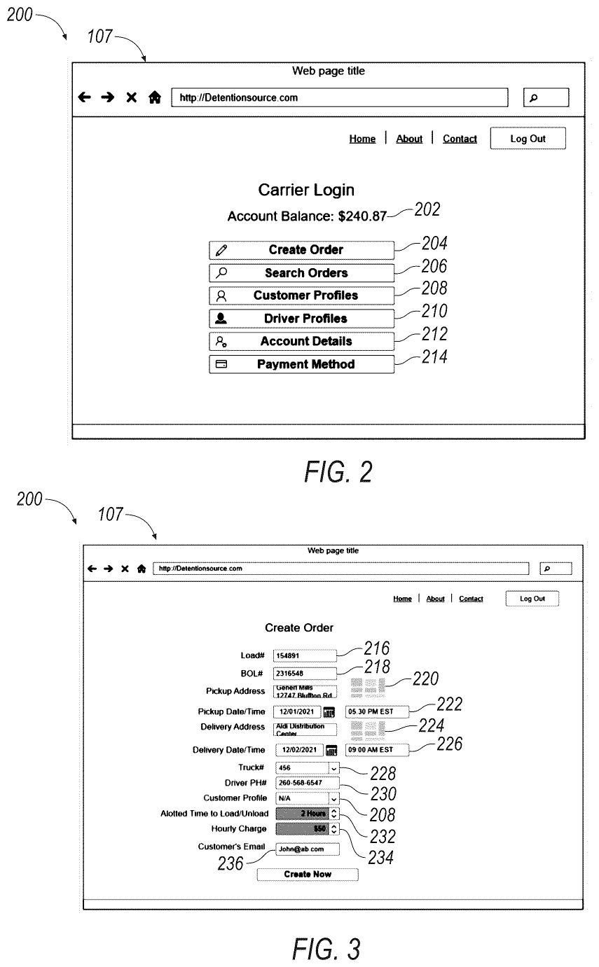

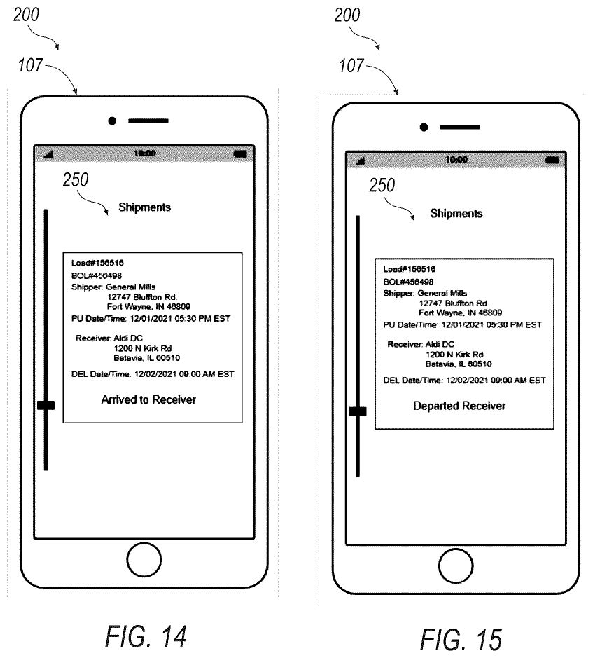

FIGS. 2-36 illustrate user interface 200 of system 100. System 100 may include a computer program including instructions stored on memory 105 and executed by processor 103 to generate and adapt the information (e.g., detention information) and operations as disclosed herein for display on user interface 200 by way of display 107. User interface 200 may include a web-based, cloud-based, and/or mobile device application (collectively, the “mobile application”). System 100 may receive, adapt, and display detention information via devices 101 and network 115 and generate notifications via a pop-up, SMS, and/or e-mail message.

As shown in FIG. 2, user interface 200 of device 101 may include carrier logins as part of detention information that may include balance/balance due 202, create order 204, search orders 206, customer profile 208, driver profiles 210, account details 212, and payment method 214. As shown in FIG. 3, user interface 200 may include order creation information as part of detention information that may include load identifier 216, BOL identifier 218, pick-up address 220, pick-up appointment date/time 222, delivery address 224, delivery appointment date/time 226, vehicle identifier 228 (e.g., truck number), user identifier 230 (e.g., driver phone number), customer profile 208, allotted time 232 (e.g., allotted load/unload or free time), hourly charge 234, and e-mail contact 236 (e.g., customer).

System 100 may receive user inputs by way of user interface 200 to create and update orders. System 100 may receive detention information via user inputs in fields, as shown in FIGS. 2-36. Detention information may include a load identifier 216 (e.g., load number), customer identifier 236 (e.g., customer e-mail), pick-up address 220, delivery address 224, pick-up and delivery appointment dates/times 222, 226, vehicle identifier 228 (e.g., truck number), driver identifier 230 (e.g., phone number), allotted time 232, and hourly charge 234. Detention information may be automatically generated and populated using location information via a mobile application, mapping service provider, ELD, a global positioning system (GPS), or a combination thereof.

System 100 may automatically generate, populate, and/or update user profiles, e.g., for drivers, customers, dispatchers, shippers, receivers, or a combination thereof. If the user has detention information such as a user profile or vehicle identifier (e.g., a driver profile or truck number associated with hauling the load), the user may select the user profile or vehicle identifier. System 100 may compare the user profile and vehicle identifier to the stored detention information and automatically assign the user (e.g., driver) to a load associated with the detention information (e.g., user profile and/or vehicle identifier).

If there is no profile setup, the user may enter a user identifier (e.g., driver or customer phone number). The user may select the user identifier (e.g., specific driver or customer) on the corresponding profile. System 100 may automatically populate detention information, e.g., the allotted time, hourly charge, and contact information (e.g., e-mail address). System 100 may receive user inputs to manually change the contact information (e.g., driver or customer e-mail address), e.g., regardless of the selected profile. System 100 may receive user inputs to manually input or accept defaults for the detention information, e.g., allotted time, hourly charge, and contact information.

System 100 may prompt user interface 200 in response to the operations herein, e.g., order creation. System 100 and user interface 200 may generate and communicate detention information as part of notifications, e.g., a pop-up, SMS, and/or e-mail message. The notifications may be manually or automatically generated by system 100 in response to the operations herein, e.g., a notification with detention information for the customer to accept, decline, or modify.

The allotted time is the free time granted to load and unload a trailer prior to incurring detention charges. In response to expiration of the allotted time, system 100 may be billed for detention on an hourly basis. For example, user interface 200 illustrates an allotted time of 2 hours and an hourly charge of $50 to be applied after the allotted time.

There are multiple ways a user can search for and edit detention information, e.g., related to an existing or new order. System 100 may receive user inputs, compare detention information relative to the user inputs, and display corresponding detention information by load identifier, BOL identifier, vehicle identifier, and/or customer profile (e.g., if a customer profile was selected at the time of creation). Users may edit or supplement the detention information, e.g., to reflect changes after the order was originally created.

System 100 may receive and communicate notifications via user interface 200, devices 101, server 102, and network 115. System 100 may transfer user selections to accept or deny updated detention information. User interface 200 of device 101 may display arrival and departure times, e.g., at the shipper and/or receiver. User interface 200 may display detention information according to user-defined triggers, e.g., in response to order completion, departure, arrival, or shipment completion. The associated detention information may be manually or automatically displayed, e.g., in response to a user request or billing. Device 101 may display a share button, receive user selections, and receive user inputs of detention information such as e-mail addresses. Device 101 may be configured to resend notifications in response to updated detention information.

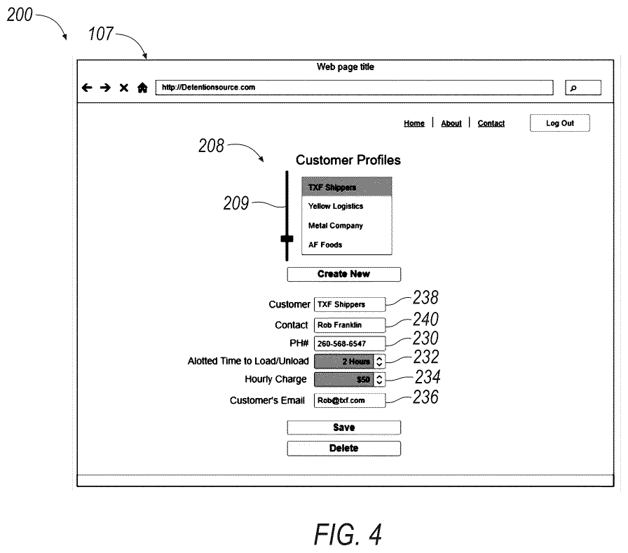

User interface 200 of device 101 may be configured to receive user inputs such that a user can create customized profiles for drivers, customers, dispatchers, shippers, and/or receivers. As shown in FIG. 4, system 100 may provide customer profile 208 as part of the detention information. Customer profile 208 may include profile selector 209, customer identifier 238, contact identifier 240, phone number 230, allotted load/unload time 232, hourly charge 234, and e-mail 236 (e.g., customer).

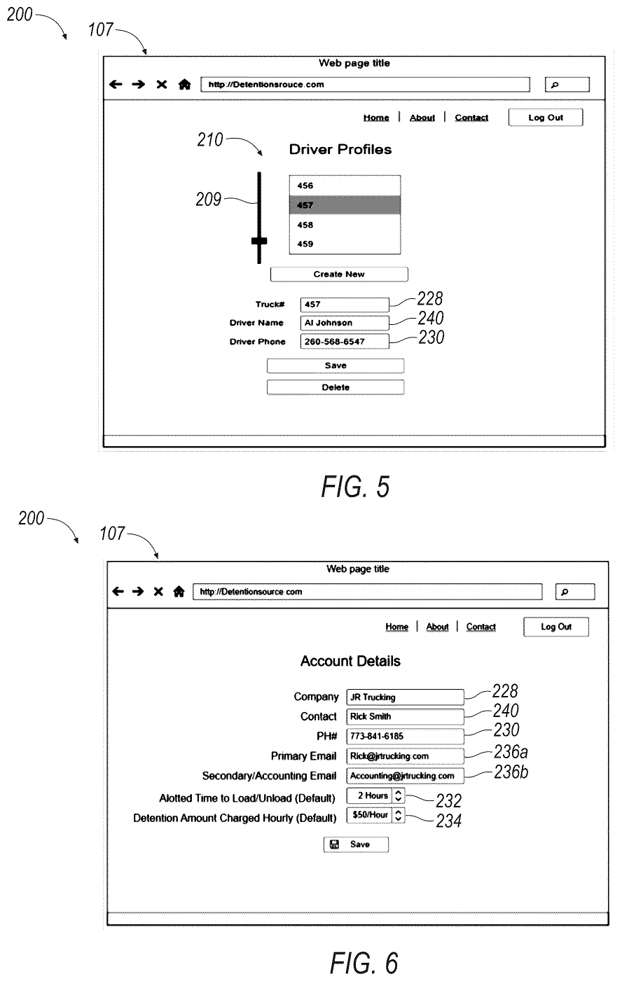

Referring to FIG. 5, user interface 200 of device 101 includes driver profile 210 as part of the detention information. Driver profile 210 may include profile selector 209, vehicle identifier 228, name 240 (e.g., driver), and phone number 230 (e.g., driver). The vehicle identifier (e.g., truck number) may be operationally associated with the user identifiers (e.g., driver name and phone number). Device 101 may receive user inputs such as the vehicle identifier and automatically populate the corresponding detention information (e.g., phone number). If system 100 does not have certain detention information (e.g., a user profile or contact information for a user), user interface 200 may receive user inputs to create or supplement the associated detention information.

As shown in FIG. 6, user interface 200 of device 101 may include account information as part of detention information such as company 228, contact 240, phone number 230, primary e-mail 236a, secondary/accounting e-mail 236b, allotted load/unload time 232, and detention charges 234. One or more devices 101, via the primary and secondary e-mails, may receive one or more notifications (e.g., via e-mail) for orders created within the associated user or company profile. The “Allotted Time to Load/Unload” and “Detention Amount Charged Hourly” are set up as the defaults on the order creation page. If a user profile is selected, these fields may change according to the user's “Allotted Time to Load/Unload” and “Detention Amount Charged Hourly.” Any detention information may be automatically or manually populated or changed from the order creation page, with existing user inputs acting as pre-defined or default selections.

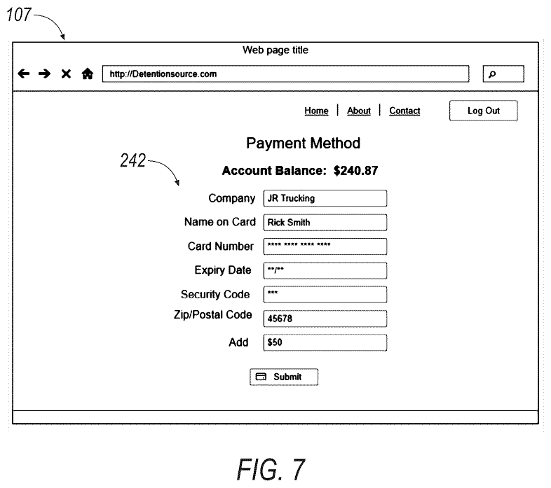

FIG. 7 illustrates user interface 200 of device 100 for displaying payment information as part of detention information, e.g., payment method inputs 242. System 100 may receive user inputs to add to the associated account balance and/or balance due by receiving debit/credit card information. System 100 may charge a pre-defined amount for every created order. In response to an order being created, the associated amount may be deducted from the user account balance/balance due. User interface 200 may display a notification for approval of the charge.

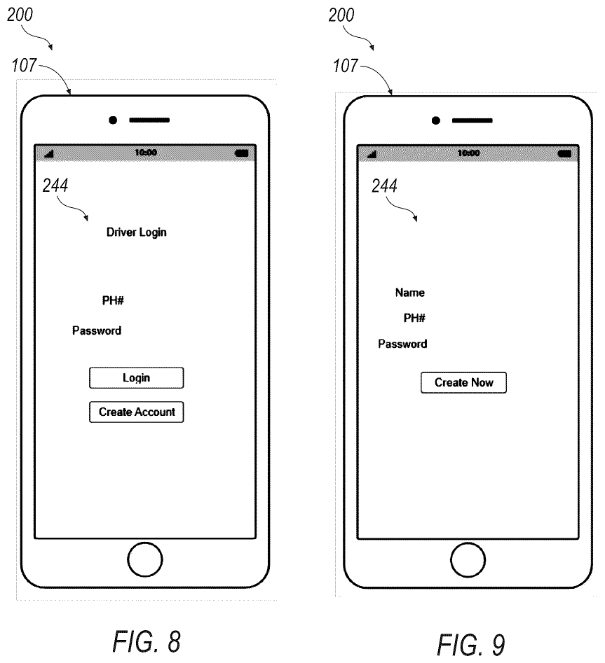

Referring to FIGS. 8-9, system 100 may receive and/or create driver login 244 as part of the detention information. The user may enter contact information (e.g., phone number) and a password to log in. If the user does not have an account, user interface 200 may receive user inputs to create an account.

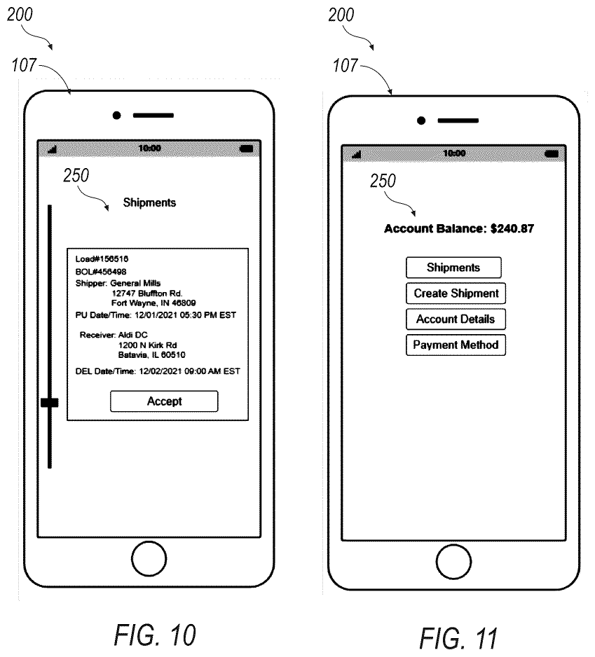

FIGS. 10-11 illustrate user interface 200 configured to receive and/or display detention information 250. Device 101 may display the computer program including a driver app dashboard with selection tabs corresponding to the operations as disclosed herein. The “Shipments” selection tab may include all created order requests sent in by other users using the web version (dispatchers, brokers, etc.). The “Create Shipment” selection tab may allow a driver to create an order from their phone, e.g., owner-operators who are out on the road and only manage their truck or a small fleet of trucks. The “Account Details” and “Payment Method” selection tabs are much like the web versions.

User interface 200 may receive and display detention information associated with shipments. When a user creates a shipment, the order is sent to the driver's user interface 200, e.g., under the “Shipments” selection tab. When the driver creates an account, accepts/enables permissions, and/or logs into the mobile application, system 100 may use location information (e.g., user-defined geofence) to detect once the driver reaches the shipper or receiver. User interface 200 may also receive user inputs indicating that the driver and/or load has arrived or departed a shipper/receiver.

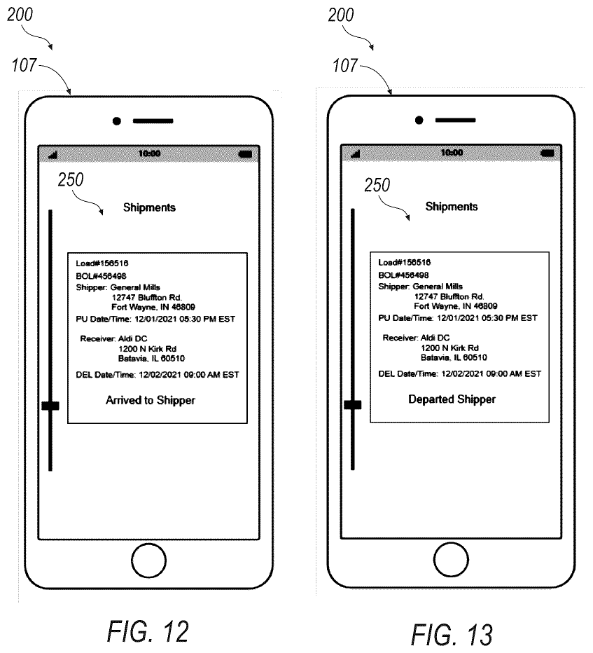

Referring to FIGS. 12, 13, 14, and 15, user interface 200 of device 101 may be configured to display tracking information 250 as part of the detention information. User interface 200 may display “Arrived to Shipper” after the driver has successfully been detected by the geofence at the shipper location. After the app triggers that the driver has arrived at the shipper, a notification may be sent to the contact information (e.g., the user's primary e-mail, secondary e-mail, and customer's e-mail) to notify the relevant users of the driver's arrival at the shipper.

System 100 and/or device 100 may generate, display, and transmit one or more notifications in response to a trigger event. The notification may include any information disclosed herein. An exemplary trigger event may include the driver (e.g., via device 101) arriving at, entering, and/or departing from detention, the shipper, and/or receiver, the detention request being received, reviewed, and/or displayed on device 101, the load being delivered or deviating from a pre-defined delivery route, or a combination thereof. The notification may be sent in response to the trigger event, regardless of whether the detention occurred at the shipper, receiver, or both. This notification may be sent to pre-defined notification contacts, e.g., relevant user's primary email, secondary email, and the customer's email. The notification may be configured to inform the pre-defined users of the driver's detention at the shipper, receiver, or both.

In response to order creation, server 101 may generate and device 101 (e.g., driver 101a) may receive a notification (e.g., via text message, e-mail, or alternative messaging services) regarding the new order. The order may also be accessible within the mobile application and devices 101 (e.g., a tracking device such as logging device 101b). Device 101 may be configured to receive, update, and enable location permissions for the mobile application.

On the scheduled pickup date, system 100 may actively monitor devices 101, e.g., the geolocation of device 101 relative to an assigned geofence of an assigned pickup location. Upon entry of driver device 101a into an assigned pickup geofence, system 100 may generate a notification to one or more devices 101. For example, the notification may include the arrival date and time, location information (e.g., the driver's location including GPS coordinates), an overhead image of the location (e.g., driver's location), and additional relevant information. System 100 may automatically dispatch notifications to one or more devices 101, e.g., the dispatcher (e.g., the individual who initiated the load) and the customer.

System 100 may generate a notification to assigned notification contacts (e.g., user's primary e-mail, user's secondary e-mail, and/or customer's e-mail) via devices 101 (e.g., driver, dispatcher, and/or shipper devices). System 100 may generate the notification in response to device 101 (e.g., driver device 101a) entering, meeting a detention threshold, or departing from the detention location. In response to device 101 reaching the geofence at the receiving location (or a user selection of a button showing “arrived”), system 100 may generate and send a notification to the assigned notification contacts to confirm the driver's arrival to the delivery location. User interface 200 may display “Arrived to Receiver” in user interface 200 in response to the driver arriving at the geofence of the receiving location.

If system 100 is unable to locate driver device 101a after its entry into an assigned geofence, device 101 may allow a user (e.g., the driver) to manually initiate notifications to inform one or more users of the driver's arrival. Subsequently, the application may continue monitoring the driver until they depart the assigned geofence of the pickup location or until the driver manually signals that they have exited the geofence.

System 100 may generate notifications according to the location information of device 101 relative to a user-defined geofence. Upon the driver departing a geofence at the shipper, a notification may be sent to the associated contact information (e.g., user's primary e-mail, secondary e-mail, and customer's e-mail) to notify the relevant users that the driver has departed the shipper with relevant information including but not limited to driver's departure date and time, driver's precise GPS coordinates, overhead image of the driver's location, and other relevant information.

If the driver is detained up to the allotted time, system 100 may generate and send a notification to any or all users that the allotted time has been reached and the driver has entered detention. Another e-mail notification may be generated and sent after the driver is detained and departs the shipper. The notification may include detention information, e.g., detailed detention charges. User interface 200 may display “Departed Shipper” in the driver's app after the driver leaves the geofence of the shipper. If the driver exits the predefined geofence under the allotted free time period from the appointment date/time as defined by terms set during order creation or outlined in the customer profile, no detention charges may be incurred.

If system 100 is unable to track the driver's departure from the predefined pickup geofence, the driver may possess the option to manually initiate notifications to inform users of their departure using the mobile application or other applicable applications.

After the driver leaves the geofence from the shipper, the next time the driver may be tracked is when the driver enters the geofence at the receiver. After the driver reaches the geofence at the receiver (or selects a button showing “arrived”), a notification may be sent to the contact information (e.g., the user's primary e-mail, secondary e-mail, and customer's e-mail) to confirm the driver's arrival to the delivery. User interface 200 may display “Arrived to Receiver” in user interface 200 after the driver arrives at the geofence of the receiver.

After the driver leaves the geofence at the receiver, a notification may be sent to the contact information (e.g., user's primary e-mail, secondary e-mail, and customer's e-mail) to notify relevant users of the driver's departure from the delivery. If the driver is detained up to the allotted time, system 100 may generate a notification to the relevant users that the allotted time has been reached. Another notification may be sent with the detention charges after the driver has been detained and after departure of the receiver. User interface 200 may display “Departed Receiver” in the driver's app after the driver departs the geofence of the receiver.

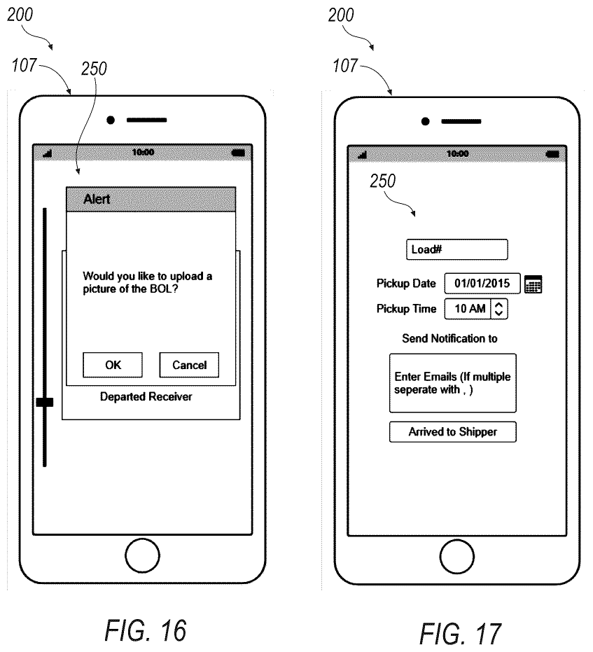

Referring to FIGS. 16-17, user interface 200 may display notifications regarding tracking information 250 and distribute such notifications. User interface 200 may display a notification prompting the user to attach a copy of the BOL. User interface 200 may prompt the user to take a picture or upload an image of the BOL, which may be stored and accessible online and via notifications. Another notification may be sent after the departed receiver notification and may display detention information, including detention charges and total charges at the shipping and receiving locations.

User interface 200 may include operations for owner-operators (drivers that own and operate their trucks). User interface 200 may create an order by receiving user inputs for a load identifier, pick-up address, pick-up date, pick-up appointment time, delivery address, delivery date, delivery appointment time, and contact information for notifications. This information by be filled out before, while or after the driver is at the shipper/receiver. After the driver hits the “Arrived to Shipper” button, system 100 may send a notification to relevant users that the driver has arrived at the shipper. System 100 may associate a pre-defined geofence of the shipper with the location information of a user (e.g., driver) associated with device 101. System 100 may monitor the location information relative to the pre-defined geofence. After they leave the geofence at the shipper, all users may be notified of the departure at the shipper. The order creation may then be moved to the “Shipments” selection tab and charged accordingly.

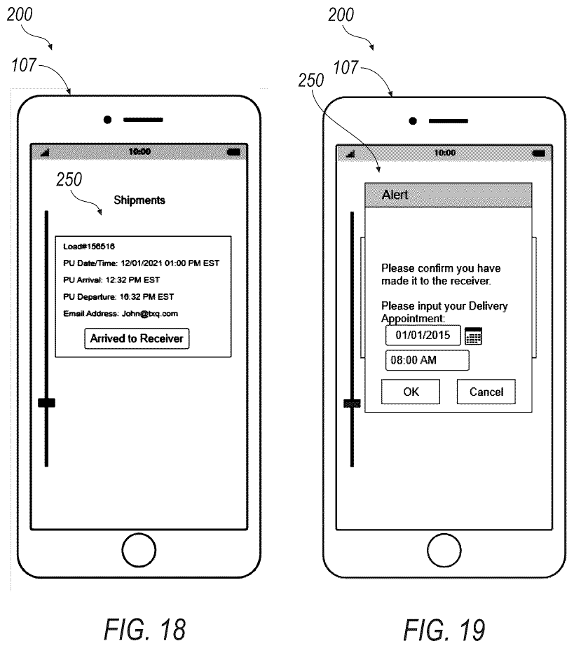

Referring to FIGS. 18-19, after the driver arrives at the receiver, user interface 200 may receive user inputs to display the “Shipments” selection tab and select “Arrived to Receiver” if the pre-defined geofence is not triggered. Systems 100 may generate a notification to relevant users regarding the driver's arrival at the receiver and may monitor the user/driver until they move outside of the pre-defined geofence. After the driver moves outside of the geofence (or manually selects “Depart from receiver”), a notification may be sent out to any or all users that the driver has departed the receiver. If there is detention at the shipping and/or receiving locations, the notification may divert to using the default allotted time and hourly charge when sending out detention request notifications.

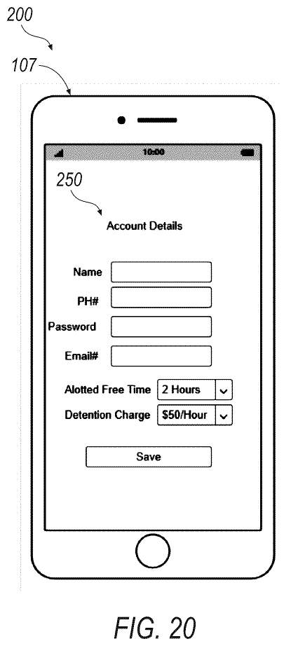

Referring to FIG. 20, user interface 200 may generate and display “Account Details” as part of the detention information. If a user/owner operator is creating orders from system 100, this is where they may enter their default allotted time and hourly charge. System 100 may also be configured to transfer or upload money to the account balance/pay balance due. System 100 may charge the user for every order created.

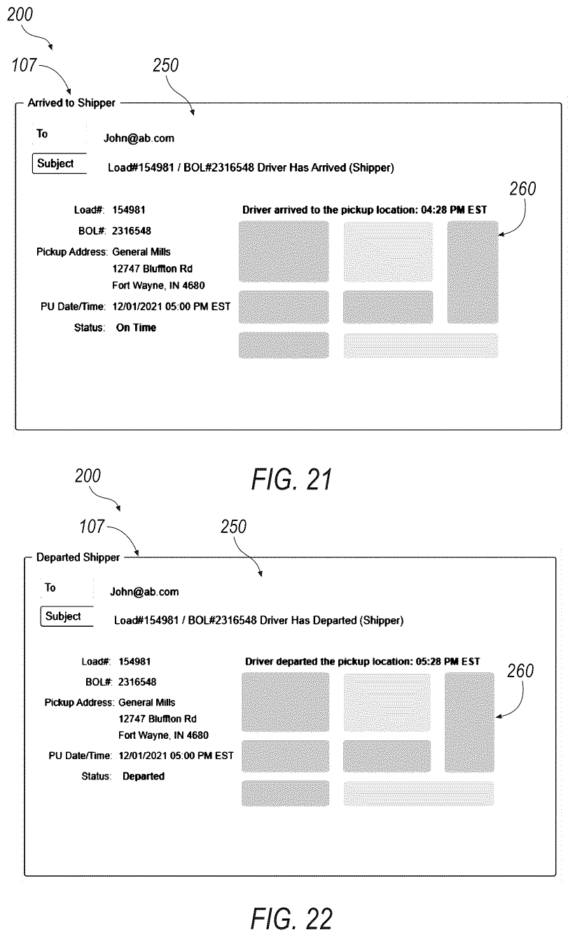

As shown in FIG. 21, user interface 200 of system 100 may be configured to communicate and display detention information 250, including location information 260. System 100 may be configured to generate and communicate automated notifications, e.g., pop-ups, SMS, or e-mail messages. System 100 may generate a notification with updated detention information to any or all of the users, e.g., in response to the driver's arrival at the shipper. The updated detention information may include a visual map pinpointing the driver's location and an associated time stamp. System 100 may initiate the notification in response to the driver reaching the user-defined geofence of the shipper or when the user manually clicks arrived, e.g., an owner operator selecting “Arrived to Shipper” within user interface 200.

As shown in FIG. 22, system 100 may generate a notification to relevant users in response to a driver leaving the shipper's geofence. System 100 may generate notifications in response to a driver being loaded within the allotted time. As shown in this example, the appointment time was 5:00 PM, the allotted time was 2 hours, and the driver departed at 05:28 PM, which is within the allotted time.

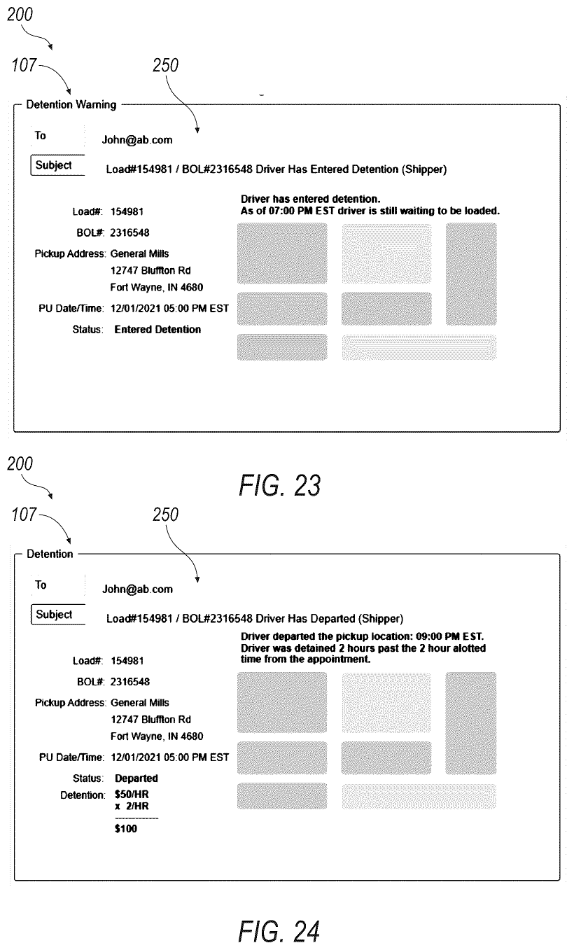

Regarding FIG. 23, system 100 may generate a notification when the allotted time has expired. In the event the driver has reached the end of the allotted time (e.g., 2 hours), any or all users may be sent the notification e-mails above advising the users that the driver is entering detention.

Referring to FIG. 24, after the driver is loaded and departs the shipper's geofence after waiting more than the Allotted time, a notification may be sent to any or all users breaking down the detention charges at the shipper.

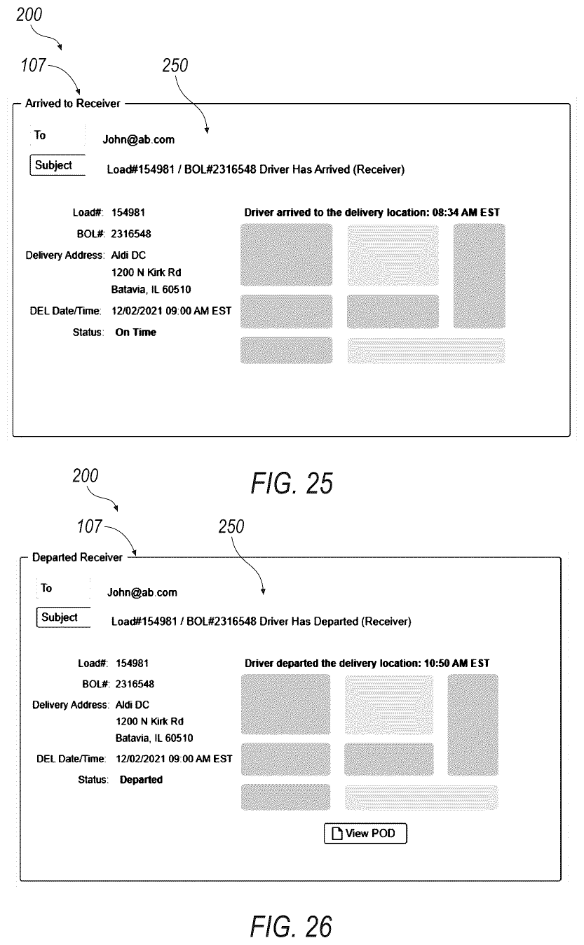

As shown in FIG. 25, after the driver reaches the geofence at the receiver, any or all users may be notified of the driver's arrival. User interface 200 may generate and display a visual map identifying the driver's location and an associated time stamp. If this is a created load within system 100, the user may need to go into system 100 under the selection tab “Shipments” and click the “Arrived to Receiver” button. User interface 200 may receive user inputs regarding the delivery appointment details. System 100 may receive user inputs confirming the notification. System 100 may also receive user inputs to generate a geofence, e.g., prior to, during, or after order creation, or departure and/or arrival at the shipper/receiver.

FIG. 26 illustrates a notification that users may receive after the driver leaves the receiver's geofence when the driver is unloaded within the “Allotted Time”/” Allotted Time to Load/Unload.” For this instance, the Allotted time was 2 Hours. As shown, the driver departed at 10:50 AM, which is within the 2-hour mark of the 09:00 AM appointment time. There is a section in the e-mail that says “View POD,” if the driver takes a picture of the BOL—this is where it may be found.

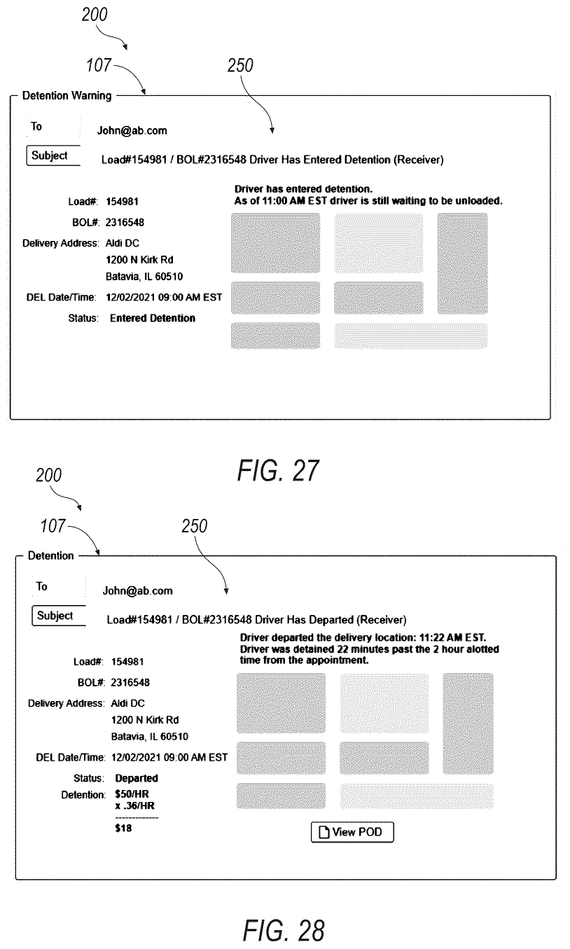

As shown in FIG. 27, Just like at the shipper, at the receiver, if the driver has reached the end of the allotted time (e.g., 2 hours) to get unloaded, any or all users may be sent a notification above advising the users that the driver is entering detention.

Referring to FIG. 28, after the driver is unloaded and departs the receiver's geofence after waiting more than the allotted time, a notification may be sent to any or all users breaking down the detention charges. There is a section in the e-mail that says “View POD” if the driver takes a picture of the BOL.

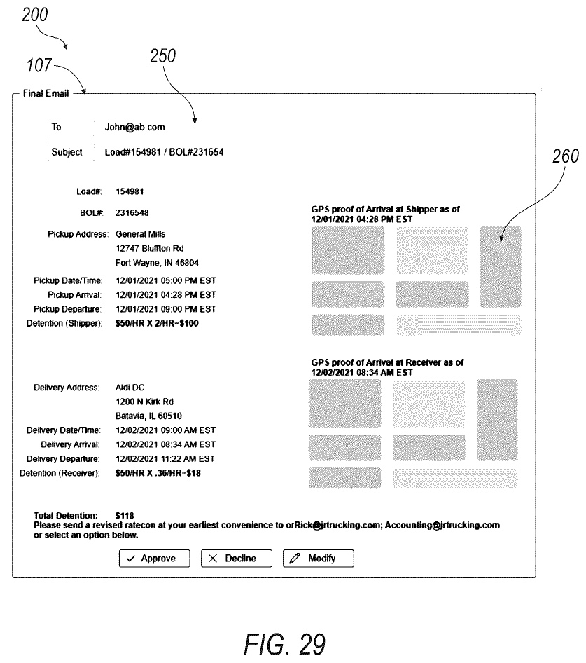

FIG. 29 illustrates another notification of system 100 that may combine the shipper and receiver notifications to create a total invoice for detention (if there is detention). The notification may show arrival times and departure times. It also shows the GPS coordinates-mapping screenshot arrival and departure times at both the shipper and receiver.

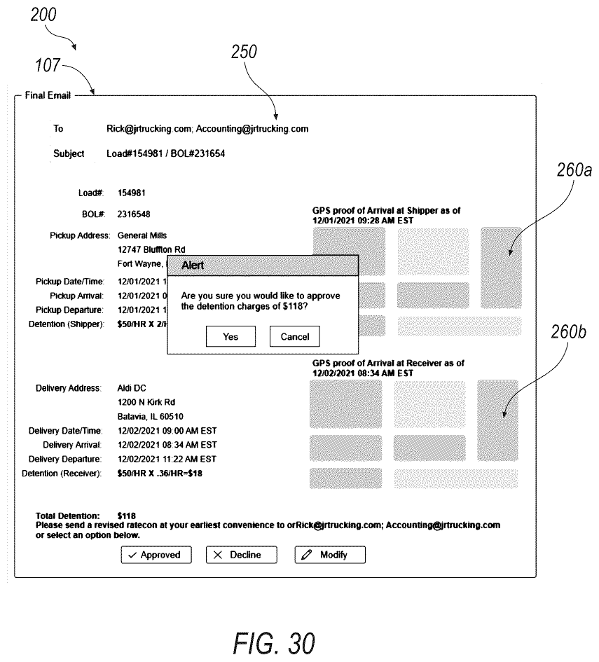

As shown in FIG. 30, if the shipper selects approve, a notification may allow the user to confirm the approval based on location information 260a, 260b (e.g., device 101 relative to shipper and receiver geofences). After the approval is confirmed, the carrier and customer may receive an approval notification as shown.

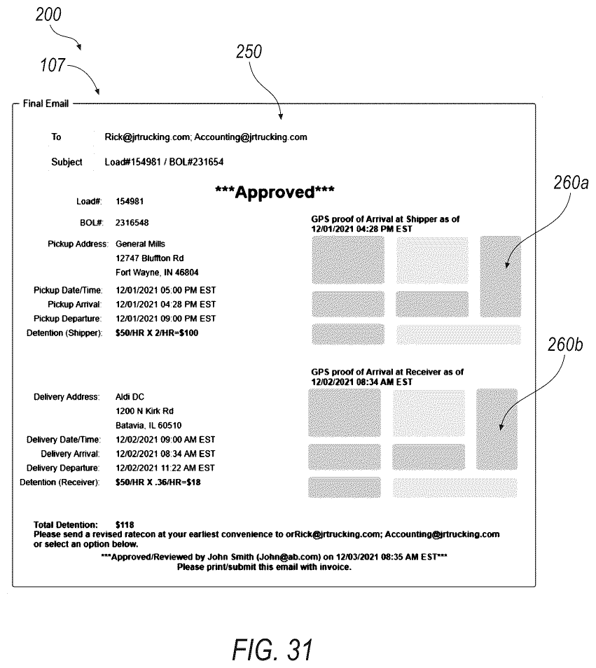

With reference to FIG. 31, if the customer approves the detention e-mail that was sent to them, the carrier and customer may both receive an e-mail back showing that it was approved at the top of the e-mail, and it may also show who approved the detention and the date in time in which it was approved at the bottom of the e-mail.

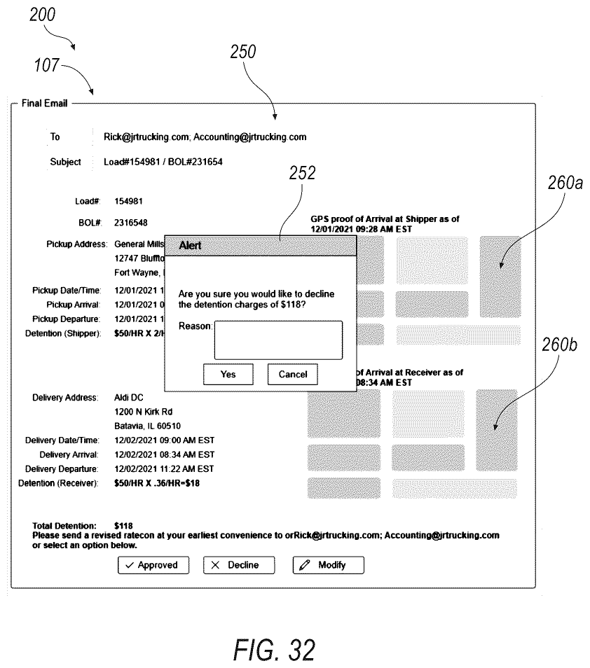

Referring to FIG. 32, if the customer declines the detention request, system 100 may generate a notification for a user to accept or decline. They may also be required to enter a reason in the text box as to why they are declining the detention request. A declined e-mail notification may be sent to both the customer and carrier after this is complete, as shown.

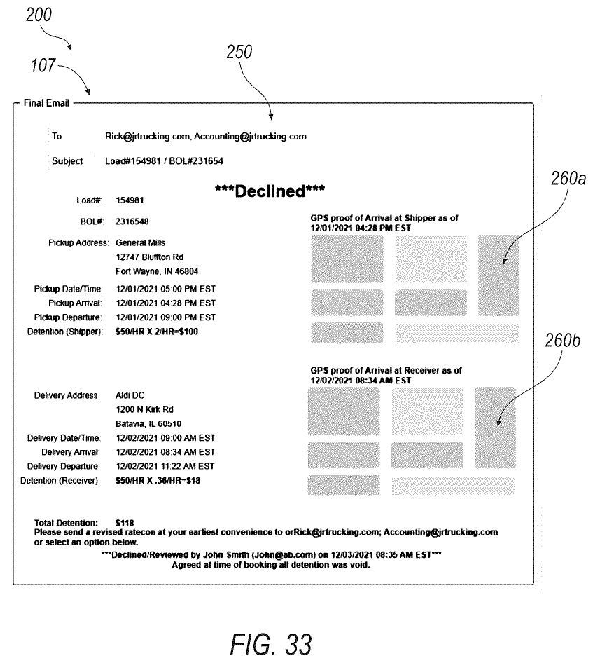

FIG. 33 illustrates user interface 200 if the detention is declined for some reason. The e-mail notification sent to the carrier and customer may have declined at the top, and at the bottom, it may give who reviewed the request along with the date and time in which the load was reviewed and the reasoning as to why it was declined.

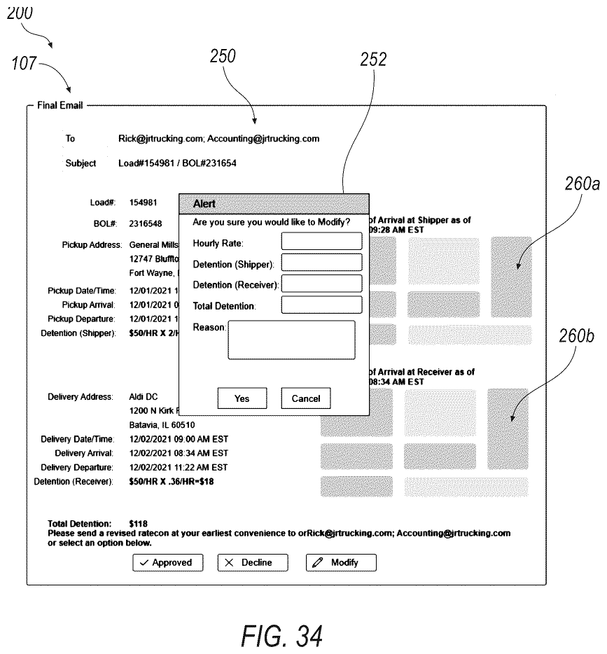

Referring to FIG. 34, system 100 may be configured to allow modifications to detention requests via notification 252 (e.g., pop-up). System 100 may generate a notification to modify the Hourly Rate, Detention (Shipper), Detention (Receiver), or Total Detention. System 100 may also prompt a reason for modifying the detention request. A modified-accepted notification may be sent to one or more users (e.g., both the customer and carrier) to confirm the modifications upon completion.

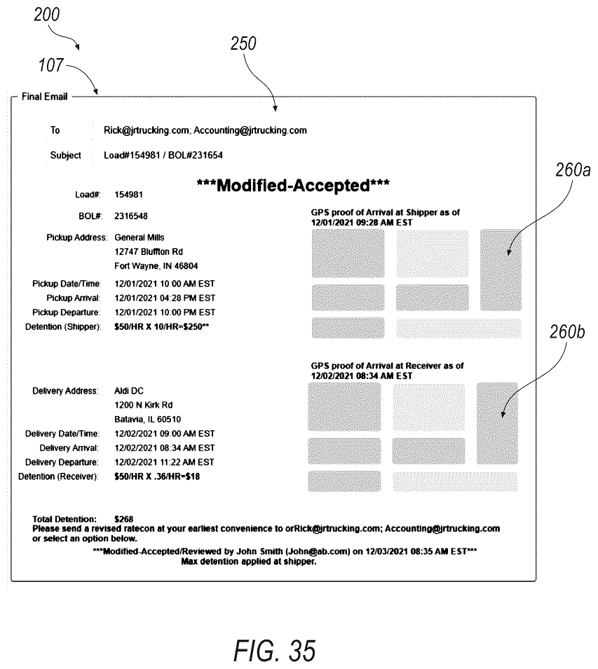

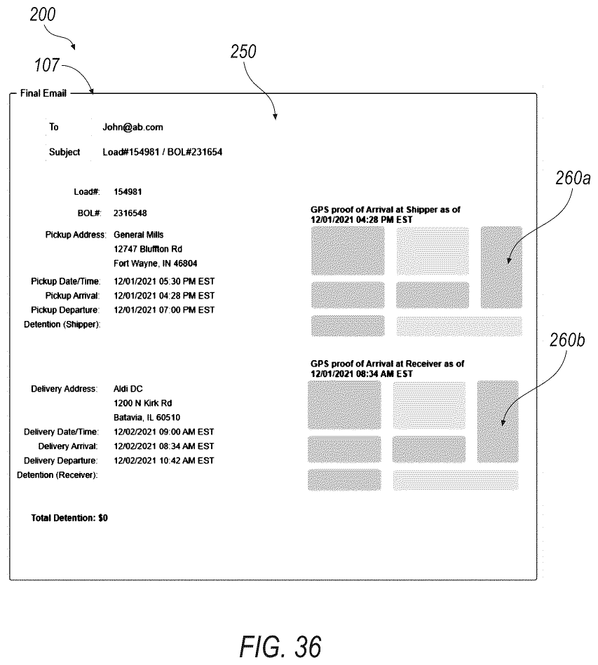

As shown in FIG. 35, the customer can modify the hourly rate, the total rate at the shipper/receiver, and the total detention at the bottom. In this case, the shipper modified the detention at the shipper they moved it to a total one-day detention max (Layover) of $250. With reference to FIG. 36, if there is no detention at either location, the fields may be blank with no charges populated (may reflect $0) or there may be no notification sent out at all.

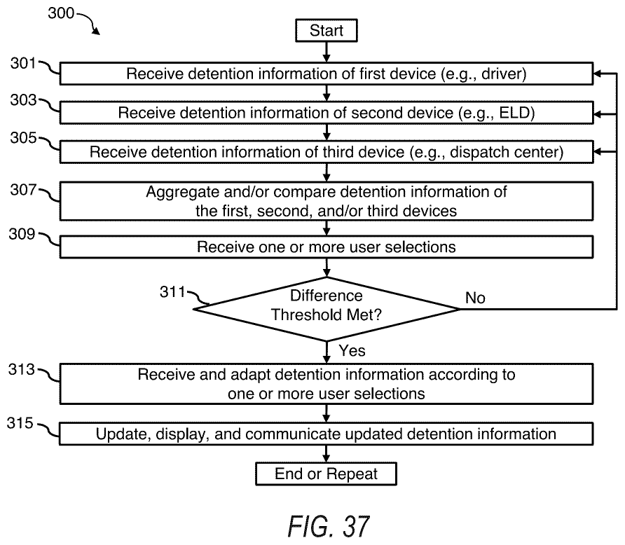

FIG. 37 illustrates process 300. At step 301, system 100 may receive detention information of first device 101 (e.g., a user such as a driver). At step 303, system 100 may receive detention information of second device 101 (e.g., electronic logging device). At step 305, system 100 may receive detention information of third device 101 (e.g., a user such as a dispatcher or an owner-operator).

At step 307, system 100 may aggregate detention information of the first, second, and/or third devices 101. At step 309, system 100 may receive detention information, including user selections, via user interface 200 of display 107. At step 311, system 100 may combine, and compared to a difference threshold, the detention information of user interface 200 and the first, second, and/or third devices 101. At step 109, system 100 may receive detention information, including user selections.

At step 111, system 100 may compare the detention information of devices 101 and user interface 200 and generate a determination of whether the comparison detention information matches a detention threshold (e.g., a predetermined value or range). If the comparison detention information is below the detention threshold, process 300 may return to any prior step, such as steps 301, 303, or 305, or a combination thereof. If the comparison determination is at, within, or above the detention threshold, process 300 may proceed to step 313.

At step 315, system 100 may update, display, and communicate updated detention information. System 100 may receive one or more user inputs to create an order by way of user interface 200. After step 315, process 300 may end or repeat.

In embodiments, process 300 may be configured for geofence-based operations. System 100 may be configured to create and notify users (e.g., a driver) of new orders upon creation. System 100 may display the order by way of user interface 200. System 100 may receive, maintain, and allow user-defined enablement of location permissions.

On the date of pick-up, system 100 may monitor after the driver enters the assigned geofenced of the pick-up location. After the driver enters the pick-up geofence, the dispatcher (person who entered the load) and the customer may both be sent a notification of the arrival date/time, the driver's precise GPS coordinates, an overhead image of the driver's location and other further information. If the system fails to locate the driver after they enter the assigned geofence, the driver may have the ability to manually trigger the notifications to the users of their arrival through system 100. System 100 may then monitor the driver until the driver leaves the assigned geofence of the pick-up location.

After the driver enters the pick-up geofence, the system may automatically track the driver until the driver leaves the pick-up geofence. If the driver departs the assigned geofence under the allotted time defined by the terms when the order was created or by the customer profile, then there may be no detention accrued. System 100 may generate a notification notifying the users of the driver's departure date/time, the driver's precise GPS coordinates, an overhead image of the driver's location, and other information.

System 100 may be configured for a user to manually trigger notifications to other users. For example, if system 100 fails to locate the driver after they depart the assigned pick-up geofence, the driver may manually trigger the notifications to other users. System 100 may generate notifications providing real-time updates of the driver's progress to other users.

If the driver's departure time is greater than the allotted time defined by the terms when the order was created or by the customer profile, then there may be detention accrued. There may be a notification sent out to both users notifying the users of the driver's departure date/time, the driver's precise GPS coordinates, an overhead image of the driver's location, detention breakdown and charges, and other information. The detention breakdown charges may be calculated based upon the hourly rate that was entered on the create order page/customer profile page (system 100 allows hourly rate in 1 min, 15 min, 30 min, or 1-hour increments rounding up.

After the driver leaves the pick-up geofence, the system won't monitor the driver again until the driver enters the delivery geofence (or next pick up would repeat the process). After the driver enters the delivery geofence, it is the same two scenarios as shown in the pick-up geofence.

If the driver departs the assigned receiver geofence under the allotted time defined by the terms when the order was created or by the customer profile, then there may be no detention accrued. System 100 may send a notification notifying the users of the driver's departure date/time, the driver's location (e.g., GPS coordinates), an overhead image of the driver's location, and other information. If the system fails to locate the driver after they depart the assigned delivery geofence, the driver may have the ability to manually trigger the notifications to the users of their departure through system 100.

If the driver's departure time is greater than the allotted time defined by the terms when the order was created or by the customer profile, then there may be detention accrued. There may be a notification sent out to both users notifying the users of the driver's departure date/time, the driver's precise GPS coordinates, an overhead image of the driver's location, detention breakdown and charges, and other information. The detention breakdown charges may be calculated based on the hourly rate that was entered on the create order page/customer profile page (system 100 allows the hourly rate to be broken down into 1 min, 15 min, 30 min, or 1-hour increments rounding up.

System 100 may generate further notifications in response to updated detention information. System 100 may generate notifications in response to a user moving relative to an appointed facilities geofence. For example, in response to a user leaving the pick-up and/or delivery geofences, system 100 may generate notifications with updated detention information. System 100 may generate notifications in response to the expiration of the allotted time and/or detention being accrued at pick-up and/or delivery locations. The notification may include detention information such as detention locations, detention accrued at each location (e.g., hourly and/or rounded), the total detention, and options to approve, deny or update.

From there, it is up to the customer (whoever's e-mail address was entered on the create order page/was associated with the customer profile) to click on the Approve or Deny option (it may most likely redirect them to the web application to do this).

If the user (e.g., customer) approves the detention request, a notification may be sent to both users reflecting the approved amount. This may act as a receipt for the carrier to use when billing the customer for the entirety of the route, fuel, detention, and any other accessories. The receipt may display the detention of where the detention took place (pick-up/delivery/both), how much detention was accrued at each location (broken down by the hour and rounded up to the nearest 1 min, 15 min, 30 min, or 1-hour increments rounding up. (whichever is selected)), and the total detention. There may also be a date of when the detention was approved, along with the customer contact who approved the detention.

If the user denies the detention, there may be a list of reason codes to select from or a text box to manually type why the detention is being denied. After the customer enters or types the reason for denying the detention, then a notification may go to the carrier (and customer) reflecting why the detention was denied, the customer contact who denied the request, and the date on which it was denied.

In the event there is detention requested at both pick-up and delivery locations, the customer may have the ability to approve/deny detention for each stop from the same final detention request notification. It is possible to have one location approved for detention and the other denied for detention. In this case, a receipt may be sent out, but it may only display the location that was approved for detention, how much detention was accrued, etc. This same receipt may also reflect why the detention was denied at the other location. This process is also done for multiple pick-ups and deliveries. The web application completely manages/monitors all detention requests for the carrier/customers.

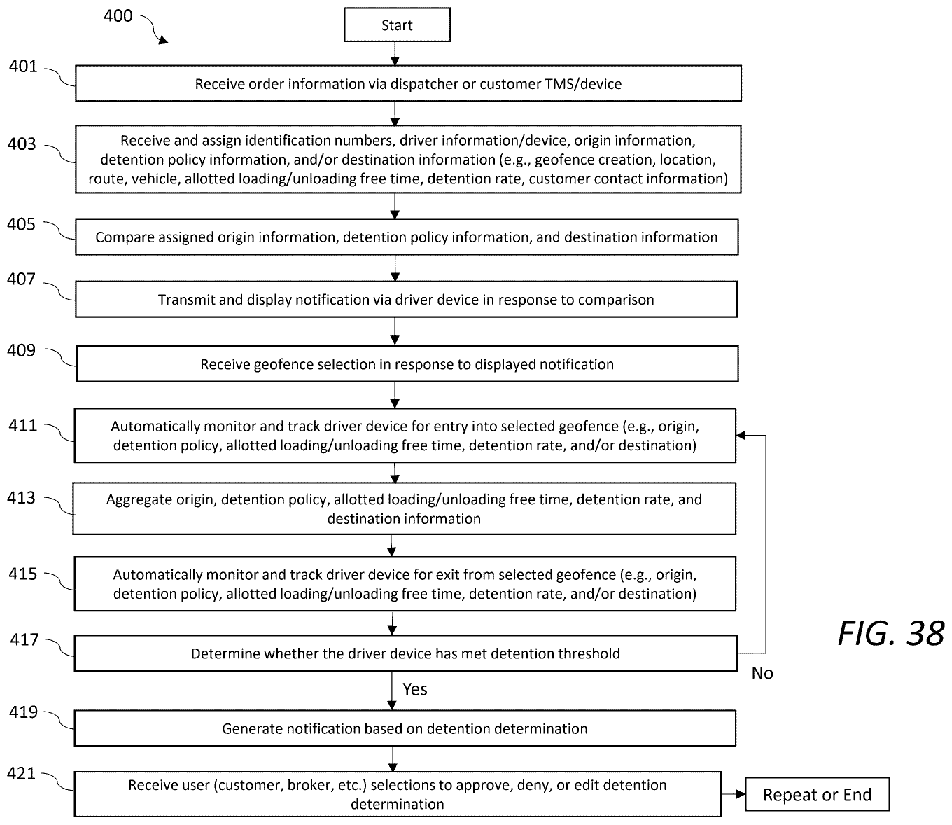

FIG. 38 illustrates process 400. At step 401, system 100 may receive order information via dispatcher or customer TMS/device of first device 101. At step 403, system 100 may receive information such as load identifier 216, BOL identifier 218, pickup address 220, pickup date/time 222, delivery address 224, delivery date/time 226, driver phone number 230, customer profile 208, hourly charge 234, allotted time to load/unload 232, customer's email 236, may be entered. Should the shipper or customer be established via ELD, all the aforementioned details may be entered automatically in search orders 206. The user may then select the relevant order and allocate the driver's phone number, ELD, or other tracking device.

At step 405, system 100 may compare assigned origin information, detention policy information, and destination information. At step 407, system 100 may transmit and display notification via driver device in response to comparison. At step 409, system 100 may receive geofence selection in response to displayed information.

At step 411, system 100 may automatically monitor and track driver device for entry into selected geofence (e.g., origin, detention policy, allotted loading/unloading time, free time, detention rate, and/or destination). At step 413, system 100 may aggregate origin, detention policy, allotted loading/unloading free time, detention rate, and destination information. At step 415 system 100 may automatically monitor and track driver device for exit out of selected geofence (e.g., origin, detention policy, allotted loading/unloading 232, free time, detention rate, and/or destination).

At step 417, system 100 may generate a determination of whether the comparison detention information matches a detention threshold (e.g., a predetermined value or range). If the comparison detention information is below the detention threshold, process 400 may return to a prior step such as step 411.

At step 419, system 100 may generate notification in response if detention determination has been met. At step 421 process 100 may receive user (e.g., customer, broker, etc.) selections to approve, deny, or edit detention determination. After step 421, the process may end or repeat.

In embodiments, process 400 may be configured for geofence-based operations. Upon order creation, the driver may receive a notification (e.g., text messages or alternative messaging services) regarding the new order. The order may also be accessible within the mobile application, device 101 (e.g., tracking device such as an ELD), wherein the driver's location permission for the application may be enabled.

On the scheduled pickup date, system 100 (e.g., via device 101, the mobile application, ELD, or another tracking device) may actively monitor the driver's entrance into the assigned geofence of an assigned pickup location. In response to the driver's entry to the assigned pickup geofenced, system 100 may generate a notification containing the arrival date and time, the driver's precise GPS coordinates, an overhead image of the driver's location, and additional relevant information may be automatically dispatched to both the dispatcher (e.g., the individual who initiated the load) and the customer.

System 100 may only generate a notification (e.g., user's primary e-mail, secondary e-mail, and customer's e-mail) to dispatcher and shipper once a driver enters the detention. After the driver reaches the geofence at the receiver (or selects a button showing “arrived”), a notification may be sent to the contact information (e.g., the user's primary e-mail, secondary e-mail, and customer's e-mail) to confirm the driver's arrival to the delivery. User interface 200 may display “Arrived to Receiver” in user interface 200 after the driver arrives at the geofence of the receiver.

If the system is unable to locate the driver after their entry into the specified geofence, the driver may possess the capability to manually initiate notifications to inform all users of their arrival via mobile application. Subsequently, the application may continue monitoring the driver until they depart the assigned geofence of the pickup location or until the driver manually signals that they have exited the geofence.

System 100 may generate notifications according to the location information of device 101 relative to a user-defined geofence. Upon the driver departing a geofence at the shipper, a notification may be sent to the associated contact information (e.g., user's primary e-mail, secondary e-mail, and customer's e-mail) to notify the relevant users that the driver has departed the shipper with relevant information including but not limited to driver's departure date and time, driver's precise GPS coordinates, overhead image of the driver's location, and other relevant information.

If the driver is detained up to the allotted time, system 100 may generate and send a notification to any or all users that the allotted time has been reached and the driver has entered detention. Another e-mail notification may be generated and sent after the driver is detained and departs the shipper. The notification may include detention information, e.g., detailed detention charges. User interface 200 may display “Departed Shipper” in the driver's app after the driver leaves the geofence of the shipper. If the driver exits the predefined geofence under the allotted free period from the appointment date/time as defined by terms set during order creation or outlined in the customer profile, no detention charges may be incurred.

If system 100 is unable to track the driver's departure from the predefined pickup geofence, the driver may possess the option to manually initiate notifications to inform users of their departure using the mobile application or other applicable applications.

After the driver leaves the geofence from the shipper, the next time the driver may be tracked is when the driver enters the geofence at the receiver. After the driver leaves the geofence at the receiver, a notification may be sent to the contact information (e.g., user's primary e-mail, secondary e-mail, and customer's e-mail) to notify relevant users of the driver's departure from the delivery.

If the driver is detained up to the allotted time, system 100 may generate a notification to the relevant users that the allotted time has been reached. Another notification may be sent with the detention charges after the driver has been detained and upon departure of the receiver (as part of the Detention Request). User interface 200 may display “Departed Receiver” in the driver's app after the driver departs the geofence of the receiver.

Detention breakdown charges may be computed using the hourly rate provided on the create order or custom profile page. The system enables the hourly rate to be refined to the nearest increment 1 min, 15 min, 30 min, or 1-hour increments rounding up. If the system cannot ascertain the driver's departure from the predefined geofence, the driver may be authorized to manually initiate notifications via the mobile application or other compatible platforms, signaling their departure to concerned users.

Following the driver's departure from the delivery geofence and the dispatch of the delivery notifications, in cases where detention charges were accrued at the pickup, delivery location, or both, a detention request notification may be dispatched to the users (e.g., the customer). This notification may comprehensively outline the breakdown of the detention occurrences, including the specific locations where detention transpired (shipper, receiver, or both), the driver's arrival and departure times at the detention sites, GPS coordinates, an overhead image of the driver's location upon arrival at the detention site, the precise amount of detention accrued at each location (e.g., itemized by the hour and rounded to the nearest selected increment of 1 minute, 15 minutes, 30 minutes or 1 hour), and the overall cumulative detention time. This notification may feature options for Approval, Denial or Edit.

Subsequently, it becomes the responsibility of the assigned customer (whose email address was entered on the create order page or associated with the customer profile) to engage with the Approve/Deny Edit option, which may redirect them to the web application for further action.

If the customer chooses to Approve the detention request, a comprehensive email notification may be distributed to both users, confirming the approved amount. This notification may serve as an official receipt, allowing the carrier to incorporate it when invoicing the customer for the entirety of the load. The recipient may explicitly present the detention location breakdown (pickup, delivery, or both), the precise duration of detention at each location (segmented by the hour and rounded to the nearest selected increment of 1 minute, 15 minutes, 30 minutes, or 1 hour), and the cumulative detention time. Additionally, the receipt may contain the date of detention approval and the contact information of the customer who sanctioned the detention.

In the event of customer denial, a range of reason codes will be provided for selection, or an option to manually input the reason for denial may be available via text box. Following the customer's entry of denial, a notification may be dispatched to both the carrier and the customer, depicting the reasons behind the denial, identifying the customer contact responsible for the denial, and indicating date of the denial.

Should detention be requested at both pickup and delivery locations, the customer may possess the capability to approve, deny, or edit detention for each stop within the same overarching detention request notification. This functionality extends to situations where one location is approved for detention location, the accumulated detention time, and pertinent details. Additionally, this receipt may expound on the reasons for denial at the other location. This process is likewise applied for scenarios involving multiple pickups and deliveries.

Any component herein may be configured to perform any of the operations or steps herein individually, collaboratively, sequentially, alternatingly, or simultaneously. Any component of system 100 may scan, receive, store, process, adapt, aggregate, display, and transmit information to any other portion of system 100. For example, one or more processors 103 of system 100 (e.g., devices 101 and server 102) may execute process 300 and/or 400 to generate any or all of user interfaces 200 by way of display 107.

Any portion of the systems, apparatuses, methods, and processes herein may occur in any arrangement, order, or sequence. Certain components or steps may occur simultaneously, others may be added, others may be omitted, or a combination thereof. This disclosure is provided for the purpose of illustrating certain embodiments and should in no way be construed to limit the claims.

The above description is intended to be illustrative and not restrictive. Many embodiments and applications other than the examples provided are apparent upon reading the above description. The scope should be determined, not with reference to the above description, but should instead be determined with reference to the claims, along with the full scope of equivalents to which such claims are entitled. Future developments may occur in the technologies discussed herein, and the disclosed systems and methods may be incorporated into such future embodiments. The embodiments of this disclosure are capable of modification, variation, and adaptation.

All terms used in the claims are intended to be assigned their broadest reasonable constructions and their ordinary meanings as understood by those knowledgeable in the technologies described herein unless an explicit indication to the contrary is made herein. Use of singular articles such as “a,” “the,” “said,” etc. should be read to recite one or more of the indicated elements unless a claim recites an explicit limitation to the contrary.

This disclosure is provided to allow the reader to ascertain the nature of the technical disclosure, but it should not be used to interpret or limit the scope or meaning of the claims. Various features of this disclosure may be grouped together in various embodiments for the purpose of streamlining the disclosure, but the claimed embodiments shall not be interpreted as requiring more features than are expressly recited in each claim. The inventive subject matter of the claims lies in less than all features of a single disclosed embodiment. The claims are hereby incorporated into the Detailed Description, with each claim standing on its own as a separately claimed subject matter.

What is claimed is:

1. A detention system comprising first, second, and third devices respectively associated with a driver device, an electronic logging device (ELD), and a dispatcher device that are in communication with each other, the driver device having a hardware processor and physical memory having a computer program including instructions that upon execution of the hardware processor provide operations comprising:
receive pre-defined geofences respectively associated with a shipper location and a receiver location;
receive user selections related to the detention information and pre-defined geofences;
determine whether the user selections have met a difference threshold; and
adapt the detention information in response to meeting the difference threshold.

2. The detention system of claim 1, the operations further comprising to receive order information from a transportation management system (TMS).

3. The detention system of claim 1, the operations further comprising to automatically monitor a driver location of the driver device relative to the pre-defined geofences.

4. The detention system of claim 3, the operations further comprising to receive and compare origin information, detention policy information, and destination information relative to the monitored driver location.

5. The detention system of claim 4, the operations further comprising to transmit and display notifications in response to comparison.

6. The detention system of claim 1, the operations further comprising to aggregate at least one of origin, detention policy, allotted time, detention rate, and destination information from the first, second, and third devices.

7. The detention system of claim 1, the operations further comprising to automatically generate notifications in response to the determination of meeting the detention threshold.

8. A detention method comprising:
receiving detention information of first, second, and third devices;
receiving pre-defined geofences respectively associated with a shipper location and a receiver location;
receiving user selections related to the detention information and pre-defined geofences;
determining whether the user selections have met a difference threshold; and
adapting the detention information in response to meeting the difference threshold.

9. The detention method of claim 8, further comprising automatically receiving order information from a transportation management system (TMS).

10. The detention method of claim 8, further comprising automatically monitoring a driver location of the driver device relative to the pre-defined geofences.

11. The detention method of claim 10, further comprising receiving and comparing origin information, detention policy information, and destination information relative to the monitored driver location.

12. The detention method of claim 11, further comprising transmitting and displaying notifications in response to comparison.

13. The detention method of claim 8, further comprising aggregating at least one of origin, detention policy, allotted time, detention rate, and destination information from the first, second, and third devices.

14. The detention method of claim 8, further comprising automatically generating notifications in response to the determination of meeting the detention threshold.

15. A driver detention device in communication with an electronic logging device (ELD) and a dispatcher device, the driver detention device having a hardware processor and physical memory including a computer program with instructions that upon execution of the hardware processor provide operations comprising:
receive pre-defined geofences respectively associated with a shipper location and a receiver location;
receive user selections related to the detention information and pre-defined geofences;
determine whether the user selections have met a difference threshold; and
adapt the detention information in response to meeting the difference threshold.

16. The driver detention device of claim 15, further providing operations to automatically receive order information from a transportation management system (TMS).

17. The driver detention device of claim 15, further comprising operations to automatically monitor a driver location relative to the pre-defined geofences.

18. The driver detention device of claim 17, further comprising operations to receive and compare origin information, detention policy information, and destination information relative to the monitored driver location.

19. The detention device of claim 15, further comprising operations to aggregate at least one of origin, detention policy, allotted time, detention rate, and destination information.

20. The detention device of claim 15, further comprising operations to determine whether the driver device has met a detention threshold.
